(19) United States
(12) Patent Application Publication
(10) Pub. No.: US 2019/0236470 A1
(43) Pub. Date: Aug. 1, 2019

(54) USER BEHAVIOR DETERMINATION FROM CORROBORATING CONTROL DATA

(71) Applicant: T-Mobile USA, Inc., Bellevue, WA (US)

(72) Inventor: Kanakrai Chauhan, Snoqualmie, WA (US)

(21) Appl. No.: 16/036,875

(22) Filed: Jul. 16, 2018

Related U.S. Application Data
(60) Provisional application No. 62/624,664, filed on Jan. 31, 2018.

(51) Int. Cl. G06N 5/04; G06N 99/00

(52) U.S. Cl. CPC G06N 5/047; G06N 99/005

(57) ABSTRACT

An example method of user behavior determination is performed by an application server. The Application server receives first telemetry data that indicates at least a first usage of a first user device of a first device type. The Application server stores the first telemetry data to one or more databases and analyzes the telemetry data. Analyzing the telemetry data includes determining one or more behavior patterns clustered by identity of a user. The Application server stores the one or more behavior patterns to a profile database and correlates the one or more behavior patterns to at least one identified behavior based on one or more behavior models. The Application server then generates a notification of the at least one identified behavior.

### CROSS-REFERENCE TO RELATED APPLICATION

This application claims the benefit of U.S. Provisional Application No. 62/624,664, entitled “USER BEHAVIOR DETERMINATION FROM CORROBORATING CONTROL DATA,” filed Jan. 31, 2018 and expressly incorporated herein by reference in its entirety.

### BACKGROUND

Wireless communication networks are widely deployed to provide various types of communication content such as, voice, data, and so on. Typical wireless communication networks may be multiple-access systems capable of supporting communication with multiple users by sharing available system resources (e.g., bandwidth, transmission power, etc.). Earlier examples of such multiple-access systems may include code division multiple access (CDMA) systems, time division multiple access (TDMA) systems, frequency division multiple access (FDMA) systems, and more recent examples include orthogonal frequency division multiple access (OFDMA) systems, and the like. Additionally, the systems can conform to specifications such as third generation partnership project (3GPP), 3GPP long-term evolution (LTE), ultra mobile broadband (UMB), evolution data optimized (EV-DO), etc.

Generally, wireless multiple-access communication systems may simultaneously support communication for multiple wireless devices. Each wireless device may communicate with one or more base stations via transmissions on forward and reverse links. The forward link (or downlink) refers to the communication link from base stations to wireless devices, and the reverse link (or uplink) refers to the communication link from wireless devices to base stations.

The wireless communication network is controlled and operated by a mobile network operator (MNO). In some scenarios, access to the wireless communication network is granted to all users associated with an active account with the MNO. For example, users comprising the family or group for an account may be granted access to the wireless communication network.

Parents and/or guardians are generally responsible for their children and their wards. However, some children may conceal their behavior via their mobile devices. Thus, a parent may feel compelled to break into the mobile device to determine what accounts and/or activities the child has been engaged in. This may be especially true in cases of emergencies (e.g., child missing, harmed, etc.).

However, security on mobile devices has continued to improve making access to the mobile device increasingly difficult, if not reasonably possible. Furthermore, the breaking into a child's mobile device may damage the parent/child relationship. Furthermore, even in the case of emergencies, the information a parent may need does not require full access to a child's mobile device.

### BRIEF DESCRIPTION OF THE DRAWINGS

The detailed description is described with reference to the accompanying figures, in which the left-most digit(s) of a reference number identifies the figure in which the reference number first appears. The use of the same reference numbers in different figures indicates similar or identical items.

FIG. 1 illustrates an example architecture of a wireless communication network.

FIG. 2 illustrates examples of user equipments (UEs).

FIG. 3 illustrates an example server.

FIG. 4 is a flow diagram of an example process for user behavior determination.

FIG. 5 is a diagram illustrating the collection of usage and behavior data.

### DETAILED DESCRIPTION

Aspects of the present disclosure are directed to computing platforms (i.e., user equipment, server, etc.), computer-readable media, and processes for determining user behavior with respect to a wireless communication network.

As mentioned above, some parents may desire access to information on a child's mobile device in order to ascertain the child's behavior. However, as mentioned above, access to the mobile device itself, may be difficult to obtain. In further examples, a user may utilize multiple devices, including different device types when accessing various services. Accordingly, aspects of the present disclosure include a server-side user behavior determination module to enable parents and/or other guardian/supervisor to ascertain a user's (e.g., child's) behavior based on the user's usage of one or more user devices.

A client device, referred to herein as a user equipment (UE), may be mobile or stationary, and may communicate with a radio access network (RAN). As used herein, the term “UE” may be referred to interchangeably as an “access terminal” or “AT”, a “wireless device”, a “subscriber device”, a “subscriber terminal”, a “subscriber station”, a “user terminal” or UT, a “mobile terminal”, a “mobile station” and variations thereof. Generally, UEs can communicate with a core network via the RAN, and through the core network the UEs can be connected with external networks such as the Internet. Of course, other mechanisms of connecting to the core network and/or the Internet are also possible for the UEs, such as over wired access networks, WiFi networks (e.g., based on IEEE 802.11, etc.) and so on. UEs can be embodied by any of a number of types of devices including but not limited to PC cards, compact flash devices, external or internal modems, wireless or wireline phones, and so on. A communication link through which UEs can send signals to the RAN is called an uplink channel (e.g., a reverse traffic channel, a reverse control channel, an access channel, etc.). A communication link through which the RAN can send signals to UEs is called a downlink or forward link channel (e.g., a paging channel, a control channel, a broadcast channel, a forward traffic channel, etc.). As used herein the term traffic channel (TCH) can refer to either an uplink/reverse or downlink/forward traffic channel

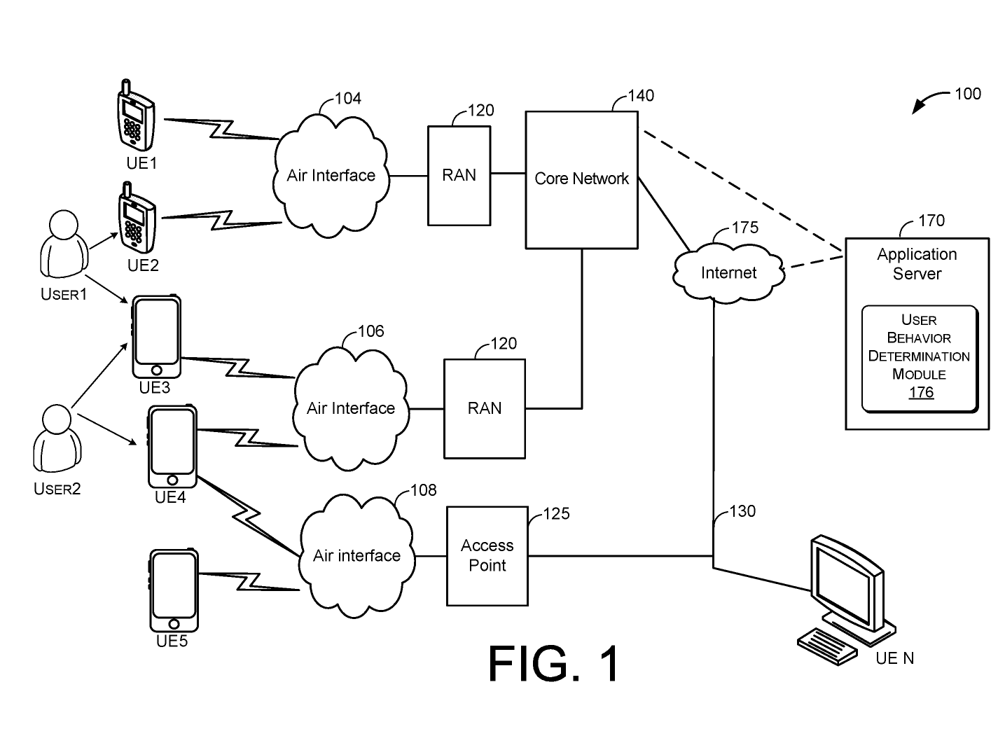

FIG. 1 illustrates a high-level system architecture of a wireless communication network 100 in accordance with various aspects. The wireless communication network 100 contains UEs 1 . . . N. The UEs 1 . . . N can include mobile phones, personal computers (e.g., a laptop computer, desktop computer, etc.), television receivers (e.g., a television, streaming device, digital video recorder, etc.), voice-activated virtual assistants (e.g., GOOGLE HOME, AMAZON ECHO, etc.), gaming consoles (e.g., MICROSOFT XBOX, SONY PLAYSTATION, NINTENDO SWITCH, 3DS, etc.), network devices (e.g., hub, switch, bridge, router, gateway, network interface card, wireless access point, modem, etc.) and so on. For example, in FIG. 1, UEs 1 . . . 2 are illustrated as cellular mobile phones, UEs 3 . . . 5 are illustrated as cellular touchscreen mobile phones or smart phones, and UE N is illustrated as a desktop computer or laptop.

Referring to FIG. 1, UEs 1 . . . N are configured to communicate with an access network (e.g., the RAN 120, an access point 125, etc.) over a physical communications interface or layer, shown in FIG. 1 as air interfaces 104, 106, 108 and/or a direct wired connection 130. The air interfaces 104 and 106 can comply with a given cellular communications protocol (e.g., CDMA, EVDO, eHRPD, GSM, EDGE, W-CDMA, LTE, etc.), while the air interface 108 can comply with a wireless IP protocol (e.g., IEEE 802.11). The RAN 120 includes a plurality of access points that serve UEs over air interfaces, such as the air interfaces 104 and 106. The access points in the RAN 120 can be referred to as access nodes or ANs, access points or APs, base stations or BSs, Node Bs, eNode Bs, and so on. These access points can be terrestrial access points (or ground stations), or satellite access points. The RAN 120 is configured to connect to a core network 140 that can perform a variety of functions, including bridging circuit switched (CS) calls between UEs served by the RAN 120 and other UEs served by the RAN 120 or a different RAN altogether, and can also mediate an exchange of packet-switched (PS) data with external networks such as Internet 175. The Internet 175 includes a number of routing agents and processing agents (not shown in FIG. 1 for the sake of convenience). In FIG. 1, UE N is shown as connecting to the Internet 175 directly (i.e., separate from the core network 140, such as over an Ethernet connection of Wi-Fi or 802.11-based network). The Internet 175 can thereby function to bridge packet-switched data communications between UE N and UEs 1 . . . 5 via the core network 140. Also shown in FIG. 1 is the access point 125 that is separate from the RAN 120. The access point 125 may be connected to the Internet 175 independent of the core network 140 (e.g., via an optical communication system such as FiOS, a cable modem, etc.). The air interface 108 may serve UE 4 or UE 5 over a local wireless connection, such as IEEE 802.11 in an example. UE N is shown as a desktop computer with a direct wired connection 130 to the Internet 175, such as a direct connection to a modem or router, which can correspond to the access point 125 itself in an example (e.g., for a Wi-Fi router with both wired and wireless connectivity).

The core network 140 is configured to support one or more communication services (e.g., Voice-over-Internet Protocol (VoIP) sessions, Push-to-Talk (PTT) sessions, group communication sessions, social networking services, etc.) for UEs that can connect to the core network 140 via the RANs 120 and/or via the Internet 175, and/or to provide content (e.g., web page downloads) to the UEs.

Referring to FIG. 1, an application server 170 is shown as connected to the Internet 175, the core network 140, or both. The application server 170 can be implemented as a plurality of structurally separate servers, or alternately may correspond to a single server.

The Information generated by a UE may be quite comprehensive. Accordingly, aspects of the present disclosure may enable a parent to ascertain much of a user's (e.g., child's) behavior by cross referencing the entire mobile experience. A child's geolocation, voice, chat, application use, as well as internet use and generally anything on a UE, may be monitored and collected, and forensic techniques applied. The information can be accessed under controlled cases ranging from determining whether a child is about to bring a gun to school and perform violence, whether a child is buying illegal drugs, or whether a child is sneaking out of the house. Accordingly, the application server 170 includes a user behavior determination module 176 that is configured to collect and store user telemetry data for enabling on demand queries from a primary account holder (PAH), or parent, or delegate, or by law enforcement in the case of a valid CALEA request. As will be described in more detail below, the stored telemetry data may be analyzed by a machine learning service module to determine one or more behavior patterns.

As mentioned above, the wireless communication network 100 may provide for multi-user to multi-device capabilities. That is, the same user may utilize multiple different devices to access the wireless communication network 100 and multiple different users may utilize the same device to access the wireless communication network 100. For example, as shown in FIG. 1, user1 may utilize UE2 as well as UE3 to access wireless communication network 100. Similarly, user2 may utilize the same UE3 as well as a different UE (i.e., UE4) to access the wireless communication network 100.

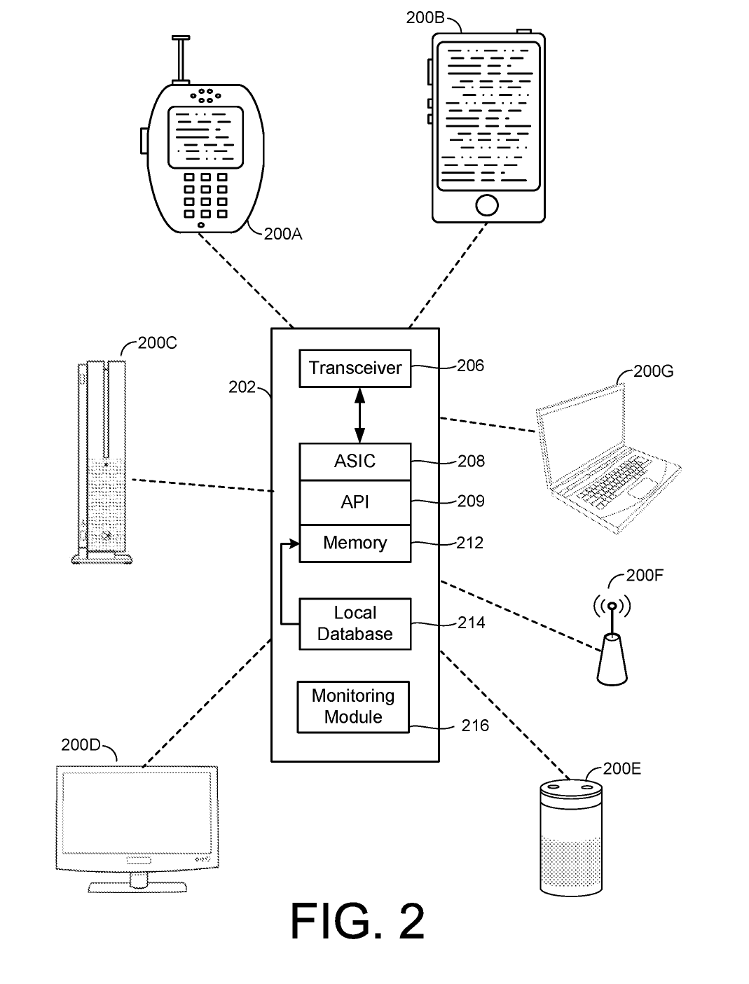

FIG. 2 illustrates examples of UEs (i.e., user devices) of various device types in accordance with embodiments of the invention. UEs 200A-G are possible implementations of any of the UEs 1-N of FIG. 1. The various device types illustrated in FIG. 2 include a mobile phone (e.g., UE 200A and UE 200B), a gaming console (e.g., UE 200C), a television receiver (e.g., UE 200D), a voice-activated virtual assistant device (e.g., UE 200E), a network device (e.g., UE 200F), and a personal computer (e.g., UE 200G).

A mobile phone device type, such as UEs 200A and 200B, may also be referred to as a cellular phone and includes portable telephones that can make and receive calls over a radio frequency link while the user is moving within a telephone service area.

A game console device type, such as UE 200C may include an electronic, digital, or computer device that outputs a video signal or visual images to display a video game that one or more users can play. In some aspects, a game console device type may use proprietary formats unlike other consumer electronics (e.g., music players, movie players, etc.) which utilize industry-wide standard formats.

A television receiver device type, such as UE 200D, may include a television set, a television tuner, a digital video recorder, and/or a video streaming device. In some aspects, a television receiver device type may include a display as well as speakers for the purpose of viewing video content.

A voice-activated virtual assistant device type, such as UE 200E, may be configured to perform tasks or services for a user based on voice commands.

A network device type, such as UE 200F, may include networking hardware and/or software, which are configured to facilitate communication and interaction between devices on a computer network. Network device types may include gateways, routers, network bridges, modems, wireless access points, networking cables, line drivers, switches, hubs, and repeaters; and may also include hybrid network devices such as multilayer switches, protocol converters, bridge routers, proxy servers, firewalls, network address translators, multiplexers, network interface controllers, wireless network interface controllers, ISDN terminal adapters and other related hardware.

A personal computer (PC) device type, such as UE 200G, may include a multi-purpose computer whose size, capabilities, and price make it feasible for individual use. In some aspects, PCs are intended to be operated directly by an end user, rather than by a computer expert or technician.

While internal components of UEs such as the UEs 200A-G can be embodied with different hardware configurations, a basic high-level UE configuration for internal hardware components is shown as platform 202 in FIG. 2. The platform 202 can receive and execute software applications, data and/or commands transmitted from the RAN 120 that may ultimately come from the core network 140, the Internet 175 and/or other remote servers and networks (e.g., application server 170, web URLs, etc.). The platform 202 can also independently execute locally stored applications without RAN interaction. The platform 202 can include a transceiver 206 operably coupled to an application specific integrated circuit (ASIC) 208, or other processor, microprocessor, logic circuit, or other data processing device. The ASIC 208 or other processor executes the application programming interface (API) 210 layer that interfaces with any resident programs in the memory 212 of the wireless device. The memory 212 can be comprised of read-only or random-access memory (RAM and ROM), EEPROM, flash cards, or any memory common to computer platforms. The platform 202 also can include a local database 214 that can store applications not actively used in memory 212, as well as other data. The local database 214 is typically a flash memory cell, but can be any secondary storage device as known in the art, such as magnetic media, EEPROM, optical media, tape, soft or hard disk, or the like.

Accordingly, an embodiment of the invention can include a UE (e.g., UE 200A-G, etc.) including the ability to perform the functions described herein. As will be appreciated by those skilled in the art, the various logic elements can be embodied in discrete elements, software modules executed on a processor or any combination of software and hardware to achieve the functionality disclosed herein. For example, the platform 202 is illustrated as including a monitoring module 216. In one aspect, monitoring module 216 is a client-side application that interacts with an operating system of the platform 202 to intercept client-side application and device use. The device/application use may then be incorporated into telemetry data that is then provided to the application server 170 for analysis. In some aspects, the telemetry data may include information regarding which applications are being used, a location of the UE (e.g., GPS location coordinates and/or Wi-Fi location), internet use, chat, voice, and so on.

Thus, in some aspects, the ASIC 208, memory 212, API 209, local database 214, and monitoring module 216 may all be used cooperatively to load, store and execute the various functions disclosed herein and thus the logic to perform these functions may be distributed over various elements. Alternatively, the functionality could be incorporated into one discrete component. Therefore, the features of the UEs 200A-G in FIG. 2 are to be considered merely illustrative and the invention is not limited to the illustrated features or arrangement.

The wireless communication between the UEs 200A and/or 200B and the RAN 120 can be based on different technologies, such as CDMA, W-CDMA, time division multiple access (TDMA), frequency division multiple access (FDMA), Orthogonal Frequency Division Multiplexing (OFDM), GSM, or other protocols that may be used in a wireless communications network or a data communications network. Voice transmission and/or data can be transmitted to the UEs from the RAN using a variety of networks and configurations. Accordingly, the illustrations provided herein are not intended to limit the embodiments of the invention and are merely to aid in the description of aspects of embodiments of the invention.

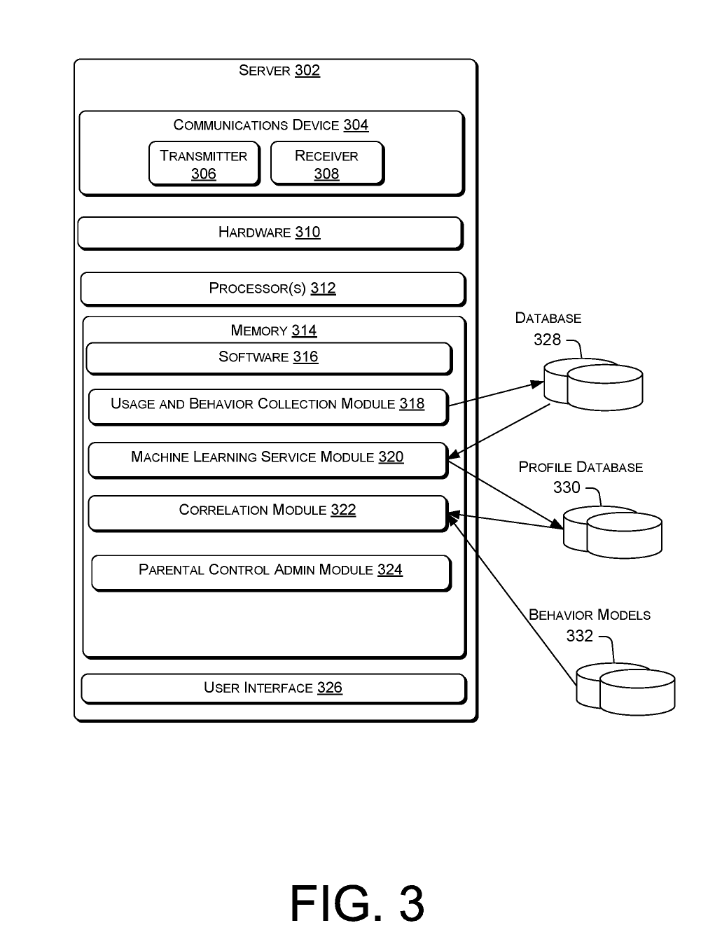

FIG. 3 illustrates an example server 302. Server 302 is one possible implementation of application server 170 of FIG. 1. The components illustrated in FIG. 3 may be implemented in different types of apparatuses in different implementations (e.g., in an ASIC, in an SoC, etc.). The illustrated components may also be incorporated into other apparatuses in a communication system. For example, other apparatuses in a system may include components similar to those described to provide similar functionality. Also, a given apparatus may contain one or more of the components. For example, an apparatus may include multiple transceiver components that enable the apparatus to operate on multiple carriers and/or communicate via different technologies.

The server 302 may include at least one communication device (represented by the communication device 304) for communicating with other nodes. For example, the communication device 304 may comprise a network interface that is configured to communicate with one or more network entities via a wire-based or wireless links. In some aspects, the communication device 304 may be implemented as a transceiver configured to support wire-based or wireless signal communication. This communication may involve, for example, sending and receiving: messages, parameters, or other types of information. Accordingly, in the example of FIG. 3, the communication device 304 is shown as comprising a transmitter 306 and a receiver 308.

The server 302 may also include other components that may be used in conjunction with the operations as taught herein. For example, the server 302 may include hardware 310, one or more processors 312, memory 314, and a user interface 326.

The hardware 310 may include additional hardware interfaces, data communications, and/or data storage hardware. For example, the hardware interfaces may include a data output device (e.g., visual display, audio speakers), and one or more data input devices. The data input devices may include, but are not limited to, combinations of one or more of keypads, keyboards, mouse devices, touch screens that accept gestures, microphones, voice or speech recognition devices, and any other suitable devices.

In addition, the server 302 may include a user interface 326 for providing indications (e.g., audible and/or visual indications) to a user and/or for receiving user input (e.g., upon user actuation of a sensing device such a keypad, a touch screen, a microphone, and so on).

The memory 314 may be implemented using computer-readable media, such as computer storage media. Computer-readable media includes, at least, two types of computer-readable media, namely computer storage media and communications media. Computer storage media includes volatile and non-volatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD), high-definition multimedia/data storage disks, or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or other transmission mechanism.

The processor 312 of server 302 may execute instructions and perform tasks under the direction of software components that are stored in memory 314. For example, the memory 314 may store various software components that are executable or accessible by the one or more processors 312 of the server 302. The various components may include software 316, a usage and behavior collection module 318, a machine learning service module 320, a correlation module 322, and a parental control admin module 324. The software 316, usage and behavior collection module 318, machine learning service module 320, correlation module 322, and parental control admin module 324, collectively, may be one possible implementation of user behavior determination module 176 of FIG. 1.

The software 316, usage and behavior collection module 318, machine learning service module 320, correlation module 322, and parental control admin module 324 may include routines, program instructions, objects, and/or data structures that perform particular tasks or implement particular abstract data types. For example, the usage and behavior collection module 318 may include one or more instructions, which when executed by the one or more processors 312 direct the server 302 to perform operations related to the collection of telemetry data. That is, the usage and behavior collection module 318 may be configured to receive telemetry data from one or more UEs and store the telemetry data into one or more databases 328. In some aspects, the usage and behavior collection module 318 may be configured to receive (and store in one or more databases 328) telemetry data from one or more other servers included in core network 140 related to the usage of the wireless communication network 100 by a UE and/or by particular user. In one example, the one or more databases 328 are included in memory 314 of server 302. Furthermore, in some aspects, access to the telemetry data stored in the one or more databases 328 may be subject to access controls consistent with current privacy laws. In yet another aspect, the usage and behavior collection module 318 may store received telemetry data according to a statistical model. Specifically, the usage and behavior collection module 318 may first identify whether the received data is cumulative and, if so, may either not store the received telemetry or may store and mark the newly received telemetry as repetitive or redundant when a machine learning algorithm is applied to the data.

The machine learning service module 320 may include one or more instructions, which when executed by the one or more processors 312 direct the server 302 to perform operations related to the analysis of telemetry data stored in the one or more databases 328 to determine user behavior patterns. In one example, the determined behavior patterns are clustered by identity and/or persona. For example, a cluster may be a behavior pattern associate with “John Smith”, or alternatively, “John Smith Personal,” or “John Smith Work,” etc.

In some aspects, server 302 may be configured to maintain a profile database 330. The profile database 330 may be included in memory 314 of server 302. In operation, the machine learning service module 320 may store one or more of the identified behavior patterns to the profile database 330.

In some examples, the machine learning service module 320 may implement a machine learning technique that is a supervised, unsupervised, or a reinforcement learning technique. Examples of supervised learning techniques include K-nearest neighbor (KNN), Naive Bayes, logistic regression, support vector machine (SVM), and others. Other supervised learning analysis techniques include linear or polynomial regression analysis, decision tress analysis, and random forests analysis. Examples of unsupervised learning analysis techniques include association analysis, clustering analysis, dimensionality reduction analysis, hidden Markov model analysis techniques, and others. Examples of clustering analysis techniques include K-means, principal component analysis (PCA), singular value decomposition (SVD), incremental clustering, and probability-based clustering techniques. The reinforcement learning technique may be, for example, a Q-learning analysis technique. The techniques described above are some examples of machine learning techniques that may be utilized by the machine learning service module 320 to generate clustered behavior patterns. These are not intended to be limiting.

In some aspects, the machine learning service module 320 may also be configured to determine (e.g., calculate) a confidence level mapping the data stored in the one or more databases 328 to a particular behavior.

Still referring to FIG. 3, the correlation module 322 may include one or more instructions, which when executed by the one or more processors 312 direct the server 302 to perform operations related to correlating one or more behavior patterns (e.g., the behavior patterns stored in the profile database 330) to at least one identified behavior. In one aspect, the correlation module 322 may perform the correlation based on one or more behavior models stored in a database 332. In some examples, the behavior models are predetermined and include a collection of known behavior patterns and associated behavior. For example, a behavior model may identify a series of UE and/or account usages with a certain dangerous activity (e.g., drug use). Thus, based on the behavior models, the correlation module 322 may correlate the identified behavior patterns with one or more known behaviors.

In other aspects, the correlation module 322 may be configured to query the one or more databases 328 to identify user behavior in response to a valid request from the primary account holder (PAH), or by a parent of the child accessing the wireless communication network 100.

In some aspects, the correlation module 322 may interface with the machine learning service module 320 to apply one or more machine learning techniques to one or more behavior patterns stored in the profile database 330.

The parental control admin module 324 may include one or more instructions, which when executed by the one or more processors 312 direct the server 302 to perform operations related to providing an administrator (e.g., a parent or PAH) with the ability to control the degree of monitoring performed. For example, the parental control admin module 324 may provide an interface (e.g., via a secure website) to allow a parent to create a user profile for their child in the profile database 330. In operation, the parental control admin module 324 may receive a request to update at least one parameter included in the profile database 330. The request to update a parameter may include a request to change the frequency with which telemetry data is to be received from a UE associated with a user. The request may also include a change to the amount of telemetry data that is to be received from the UE, as well as what types of telemetry data are to be collected by the UE, itself. For example, one parameter included in the profile database may specify that the UE is to collect text messaging telemetry data, but to exclude GPS or other location information.

The parental control admin module 324 may communicate with the monitoring module 216 on the child's UE to update the monitoring module 216 with the updated parameters (e.g., to control how much, how often, and or what types of information are collected by the UE). In some embodiments, the monitoring module 216 may determine that the user of the respective UE is of the age of majority (e.g. 18 in most states), in which case the monitoring module 216 may expose a user setting on the UE to enable the user to opt out of parental settings. Otherwise, the UE will either not expose an opt out user setting or may disable the setting.

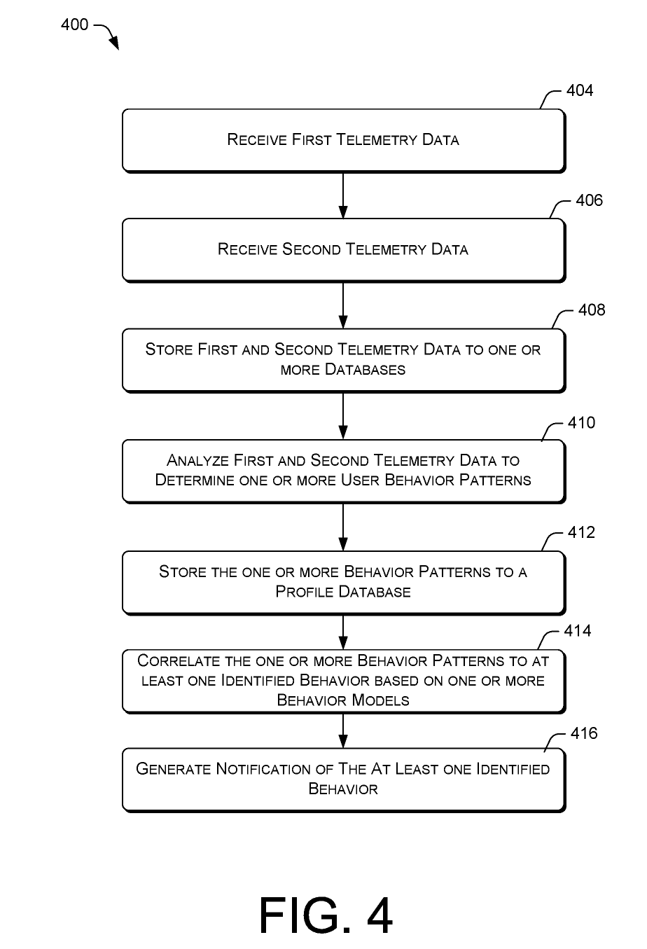

FIG. 4 is a flow diagram of an example process 400 for user behavior determination. Process 400 is one possible process performed by application server 170 of FIG. 1 and/or server 302 of FIG. 3. Process 400 will be described with reference to FIGS. 2-4.

In process blocks 404 and 406, the usage and behavior collection module 318 collects (e.g., receives) telemetry data. As mentioned above, the usage and behavior collection module 318 may receive the telemetry data from one or more UEs by way of the monitoring module 216 (e.g., see FIG. 2). In one example, the received data relates to activities and/or device usage data collected locally at the UE. In one aspect, the monitoring module 216 may periodically upload telemetry data to the server 302 according to a predetermined schedule. In another example, the server 302 may send a request to the monitoring module 216 for the latest telemetry data. As mentioned above, a user may utilize multiple UEs, including UEs of various device types. Thus, in some examples, the usage and behavior collection module 318 receives first telemetry data that indicates a first usage of a first user device of a first device type, and also receives second telemetry data that indicates a second usage of a second user device of a second (e.g., different) device type. Accordingly, aspects of the present disclosure are not limited to receiving and analyzing telemetry data from a single device type (e.g., mobile phone). Instead, server 302 may be configured to determine user behavior based on telemetry data collected from various devices. For example, telemetry data collected from a mobile phone indicating a current location of the user may be combined with web browsing data collected from a laptop to determine that the user is engaging in a dangerous or illicit activity (e.g., drug use).

The usage and behavior collection module 318 may then store the collected telemetry data to the one or more databases 328 (i.e., process block 408).

The telemetry data stored in the one or more databases 328 may also include an indication of services utilized by a particular account (e.g., text messaging, phone calling, etc.). The telemetry data may further include, for example, which applications have been launched, and the like. In addition, the telemetry data may include associated timing information, such as the duration of a usage (e.g., how long was the web browser open) and/or a respective time that the usage occurred (e.g., web browsing occurred immediately after text message was sent).

In a process block 410, the machine learning service module 320 may then analyze the telemetry data stored in the one or more databases 328 to determine behavior patterns clustered by an identity of a user. For example, machine learning service module 320 may apply one or more machine learning techniques to the data stored in the databases 328 to associate the device usages (e.g., telemetry data) with one or more behavior patterns of the identified user. In one example, the machine learning service module 320 may maintain a plurality of clusters and an associated behavior pattern of each in profile database 330 (e.g., process block 412).

Next, in a process block 414, the correlation module 322 may query the one or more databases 328 based on a request from a parent and/or a valid request from law enforcement. As mentioned above, the correlation module 322 may interface with the machine learning service module 320 to apply one or more machine learning techniques to the one or more behavior patterns of the user and the predetermined behavior models to identify a particular behavior.

In one example, the correlation module 322 may be configured to periodically query the one or more databases to automatically generate a notification in response to identifying one or more predefined behaviors (e.g., process block 416). For example, a parent, by way of the parental controls admin module 324 may configure the correlation module 322 to notify the parent if a dangerous behavior (e.g., child taking drugs) is identified. In one example, the notification may be sent to a UE associated with the parent via a text message.

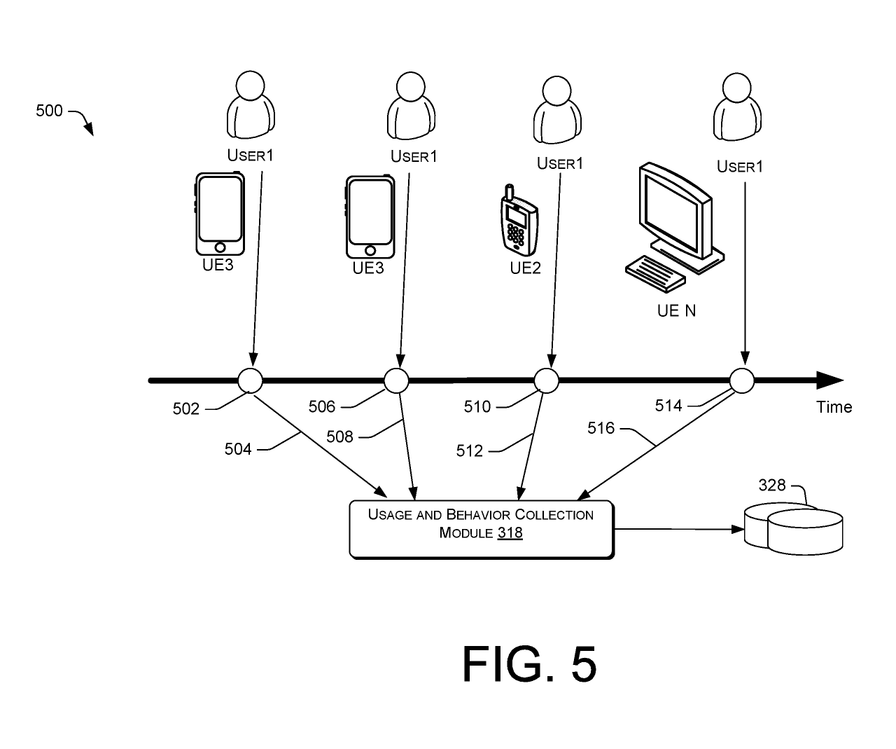

FIG. 5 is a diagram illustrating the collection of equipment (i.e., UE) usage and behavior data. Specifically, it illustrates how a user1 progresses over time and develops a historical (time-ordered series) of equipment usage and behavior. In example, the illustrated usage events 502, 506, 510, and 514, collectively, represent a time-ordered series of events.

For example, User1 may interact with UE3 to generate a usage event 502. Usage event 502 could possibly be User1 using UE3 to access a web site at a particular URL. User1 may also make some purchases during the usage event 502. Data collected during usage event 502 and subsequent usage events may be sent from the monitoring module 216 to usage and behavior collection module 318 as telemetry data 504. The usage and behavior collection module 318 then stores records of usage event 502 to the one or more databases 328.

As User1 progresses over time, telemetry data (e.g., 508, 512, and 516) of subsequent usage events (e.g., 506, 510, and 514) are also collected by the usage and behavior collection module 318. For example, as shown via usage event 506, User1 may later interact with a different information system (e.g., different website) using the same UE3. For example, usage event 506 may be User1 using UE3 to update the user's social network records at another URL. Usage and behavior collection module 318 may receive the telemetry data 508 associated with usage event 506 and store the telemetry data 508 to the one or more databases 328.

Accordingly, the telemetry data collected with respect to a particular user need not be specific to a particular site or to a particular type of interaction. Any definable and observable user event whose parameters may be captured is a candidate for storing as one or more telemetry data for a user.

Furthermore, telemetry data for a user need not be specific to a particular client device. As shown via usage event 510, which may be after a number of other usage events, User1 may use a different client device, here client UE2 to interact with an information system. Usage event 510 could potentially be User1 further updating the user's social network records, perhaps to upload a picture just taken with UE2. Again, usage and behavior collection module 318 may receive the telemetry data 512 and store the telemetry data 512 to the one or more databases 328.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A method of user behavior determination performed by an application server, the method comprising:
receiving, at the application server, first telemetry data, wherein the first telemetry data indicates at least a first usage of a first user device of a first device type;
storing the first telemetry data to one or more databases;
analyzing, at the application server, telemetry data, including the first telemetry data stored in the one or more databases, to determine one or more user behavior patterns clustered by an identity of a user;
storing the one or more behavior patterns to a profile database;
correlating the one or more behavior patterns to at least one identified behavior based on one or more behavior models; and
generating a notification of the at least one identified behavior.

2. The method of claim 1, further comprising:
receiving, at the application server, second telemetry data, wherein the second telemetry data indicates at least a second usage of a second user device of a second device type; and
storing the second telemetry data to the one or more databases, wherein analyzing the telemetry data includes analyzing the first telemetry data and the second telemetry data to determine the one or more user behavior patterns.

3. The method of claim 2, wherein the first device type is a device type selected from the group consisting of a mobile phone, a personal computer, a television receiver, a voice-activated virtual assistant device, a gaming console, and a network device, and wherein the second device type is a different device type selected from the group.

4. The method of claim 1, wherein receiving the first telemetry data comprises communicating with a monitoring module of the first user device, wherein the monitoring module of the first user device is configured to intercept client-side application or device use and to incorporate the application or device use into the first telemetry data.

5. The method of claim 1, further comprising:
receiving, at the application server, third telemetry data, wherein the third telemetry data indicates one or more activities or services utilized by an account of the user; and
storing the third telemetry data to one or more databases, wherein analyzing the telemetry data includes analyzing the third telemetry data to determine the one or more behavior patterns.

6. The method of claim 1, wherein analyzing the telemetry data comprises applying, by a machine learning service module of the application server, one or more machine learning techniques to the telemetry data stored in the one or more databases to associate the first usage with the one or more behavior patterns of the user.

7. The method of claim 1, wherein correlating the one or more behavior patterns to the at least one identified behavior based on the one or more behavior models comprises applying, by a machine learning service module of the application server, one or more machine learning techniques to the one or more behavior patterns of the user.

8. The method of claim 1, further comprising:
maintaining a user profile corresponding to the user, wherein the user profile includes at least one parameter selected from the group consisting of: a frequency with which telemetry data is to be received from the first user device, an amount of the telemetry data that is to be received from the first user device, or an indication of one or more types of information that are to be included in the telemetry data; and
communicating the at least one parameter to the first user device.

9. The method of claim 8, further comprising:
receiving, at the application server, a request to update the at least one parameter, wherein the request is received from an administrator of the user profile;
modifying the user profile with an updated parameter in response to the request; and
communicating the updated parameter to the first user device.

10. The method of claim 1, further comprising:
sending, by the application server, the notification of the at least one identified behavior, to an administrator of the user profile.

11. The method of claim 10, wherein sending the notification comprising sending a text message to a user device associated with the administrator.

12. An application server, comprising:
at least one processor; and
at least one memory coupled to the at least one processor, the at least one memory having instructions stored therein, which when executed by the at least one processor, direct the application server to:
receive first telemetry data, wherein the first telemetry data indicates at least a first usage of a first user device of a first device type;
receive second telemetry data, wherein the second telemetry data indicates at least a second usage of a second user device of a second device type, wherein at least one of the first telemetry data or the second telemetry data comprises a time-ordered series of device usages;
store the first telemetry data and the second telemetry data to one or more databases;
analyze telemetry data, including the first telemetry data and the second telemetry data, stored in the one or more databases to determine one or more user behavior patterns clustered by an identity of a user;
store the one or more behavior patterns to a profile database;
correlate the one or more behavior patterns to at least one identified behavior based on one or more behavior models; and
generate a notification of the at least one identified behavior.

13. The application server of claim 12, wherein the first device type is a device type selected from the group consisting of a mobile phone, a personal computer, a television receiver, a voice-activated virtual assistant device, a gaming console, and a network device, and wherein the second device type is a different device type selected from the group.

14. The application server of claim 12, wherein the instructions to correlate the one or more behavior patterns to the at least one identified behavior based on one or more behavior models comprises instructions to apply, by a machine learning service module of the application server, one or more machine learning techniques to the one or more behavior patterns of the user.

15. The application server of claim 12, wherein the instructions further direct the application server to:
maintain a user profile corresponding to the user, wherein the user profile includes at least one parameter selected from the group consisting of: a frequency with which telemetry data is to be received from the first or second user devices, an amount of the telemetry data that is to be received from the first or second devices, or an indication of one or more types of information that are to be included in the telemetry data; and
communicate the at least one parameter to at least one of the first user device or the second user device.

16. The application server of claim 15, wherein the instructions further direct the application server to:
receive a request to update the at least one parameter, wherein the request is received from an administrator of the user profile;
modify the user profile with an updated parameter in response to the request; and
communicate the updated parameter to at least one of the first user device or the second user device.

17. One or more non-transitory computer-readable media storing computer-executable instructions, which when executed by the at least one processor of an application server, direct the application server to:
receive first telemetry data, wherein the first telemetry data indicates at least a first usage of a first user device of a first device type;
receive second telemetry data, wherein the second telemetry data indicates at least a second usage of a second user device of a second device type, wherein at least one of the first telemetry data or the second telemetry data comprises a time-ordered series of device usages;
store the first telemetry data and the second telemetry data to one or more databases;
analyze telemetry data, including the first telemetry data and the second telemetry data, stored in the one or more databases to determine one or more user behavior patterns clustered by an identity of a user;
store the one or more behavior patterns to a profile database;
correlate the one or more behavior patterns to at least one identified behavior based on one or more behavior models, wherein the instructions to correlate the one or more behavior patterns to the at least one identified behavior based on one or more behavior models comprises instructions to apply, by a machine learning service module of the application server, one or more machine learning techniques to the one or more behavior patterns of the user; and
generate a notification of the at least one identified behavior.

18. The one or more non-transitory computer-readable media of claim 17, wherein the first device type is a device type selected from the group consisting of a mobile phone, a personal computer, a television receiver, a voice-activated virtual assistant device, a gaming console, and a network device, and wherein the second device type is a different device type selected from the group.

19. The one or more non-transitory computer-readable media of claim 17, wherein the instructions further direct the application server to:
maintain a user profile corresponding to the user, wherein the user profile includes at least one parameter selected from the group consisting of: a frequency with which telemetry data is to be received from the first or second user devices, an amount of the telemetry data that is to be received from the first or second devices, or an indication of one or more types of information that are to be included in the telemetry data; and
communicate the at least one parameter to at least one of the first user device or the second user device.

20. The one or more non-transitory computer-readable media of claim 19, wherein the instructions further direct the application server to:
receive a request to update the at least one parameter, wherein the request is received from an administrator of the user profile;
modify the user profile with an updated parameter in response to the request; and
communicate the updated parameter to at least one of the first user device or the second user device.
